(19) United States
(12) Patent Application Publication
(10) Pub. No.: US 2025/0287450 A1
(43) Pub. Date: Sep. 11, 2025

(54) SYSTEMS AND METHODS FOR ENHANCED SMALL DATA TRANSMISSIONS

(71) Applicant: QUALCOMM Incorporated, San Diego, CA (US)

(72) Inventors: Ramakrishna Suresh Shanbhag, San Diego, CA (US); Bapineedu Chowdary Gummadi, Hyderabad (IN); Gayathri Karthikeyan, Hyderabad (IN)

(21) Appl. No.: 18/597,646

(22) Filed: Mar. 6, 2024

(51) Int. Cl. H04W 76/20; H04B 17/318; H04W 74/0816; H04W 74/0833

(52) U.S. Cl. CPC H04W 76/20; H04B 17/328; H04W 74/0816; H04W 74/0833

(57) ABSTRACT

In one aspect, a method of wireless communication includes receiving, by a user equipment (UE), small data transmission (SDT) configuration information. The method also includes obtaining, by the UE, data for transmission via SDT and SDT parameter information associated with the data for transmission via SDT. The method includes determining, by the UE, a SDT transmission delay based on the SDT parameter information for the data and based on the SDT configuration information. The method further includes transmitting, by the UE, a SDT based on one or more SDT conditions and including the data after the SDT transmission delay. Other aspects are described and claimed.

### BACKGROUND

### Field

Aspects of the present disclosure relate generally to wireless communication systems, and more particularly, to small data transmission (SDT) operations. Certain embodiments of the technology discussed below can enable and provide enhanced SDT operations, including conditional transmission of SDTs to optimize bandwidth usage and reduce power consumption.

### Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In one aspect of the disclosure, a method of wireless communication includes receiving, by a user equipment (UE), small data transmission (SDT) configuration information. The method also includes obtaining, by the UE, data for transmission via SDT and SDT parameter information associated with the data for transmission via SDT. The method includes determining, by the UE, a SDT transmission delay based on the SDT parameter information for the data and based on the SDT configuration information. The method further includes transmitting, by the UE, a SDT based on one or more SDT conditions and including the data after the SDT transmission delay.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system.

FIG. 2 is a block diagram illustrating a design of a base station and a UE configured according to one aspect of the present disclosure.

FIG. 3A is a diagram of a first example of small data transmission (SDT) operations with a two-step random access channel (RACH) procedure according to some aspects of the present disclosure.

FIG. 3B is a diagram of a second example of SDT operations with a four-step RACH procedure according to some aspects of the present disclosure.

FIG. 3C is a diagram of a third example of SDT operations with a configured grant according to some aspects of the present disclosure.

FIG. 4 is a block diagram illustrating an example of a wireless communications system that performs conditional SDT operations according to some aspects of the present disclosure.

FIG. 5 is a ladder diagram of an example of conditional SDT operations according to some aspects of the present disclosure.

FIG. 6 is a ladder diagram of another example of conditional SDT operations according to some embodiments of the present disclosure.

FIG. 7 is a ladder diagram of another example of conditional SDT operations according to some embodiments of the present disclosure.

FIG. 8 is a ladder diagram of another example of conditional SDT operations according to some embodiments of the present disclosure.

FIG. 9 is a block diagram of an example of evaluating SDT transmission conditions for conditional SDT operations according to some embodiments of the present disclosure.

FIG. 10 is a block diagram of an example of evaluating subscriptions for conditional SDT operations in dual subscription modes according to some embodiments of the present disclosure.

FIGS. 11A-11C are each a diagram illustrating an example scenario of conditional SDT transmission operations according to some embodiments of the present disclosure.

FIG. 12 is a flow diagram illustrating example blocks executed by a UE configured according to an aspect of the present disclosure.

FIG. 13 is a block diagram conceptually illustrating a design of a UE configured to perform conditional SDT transmission operations according to some embodiments of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHZ, subcarrier spacing may occur with 120 kHz over a 500 MHz bandwidth.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

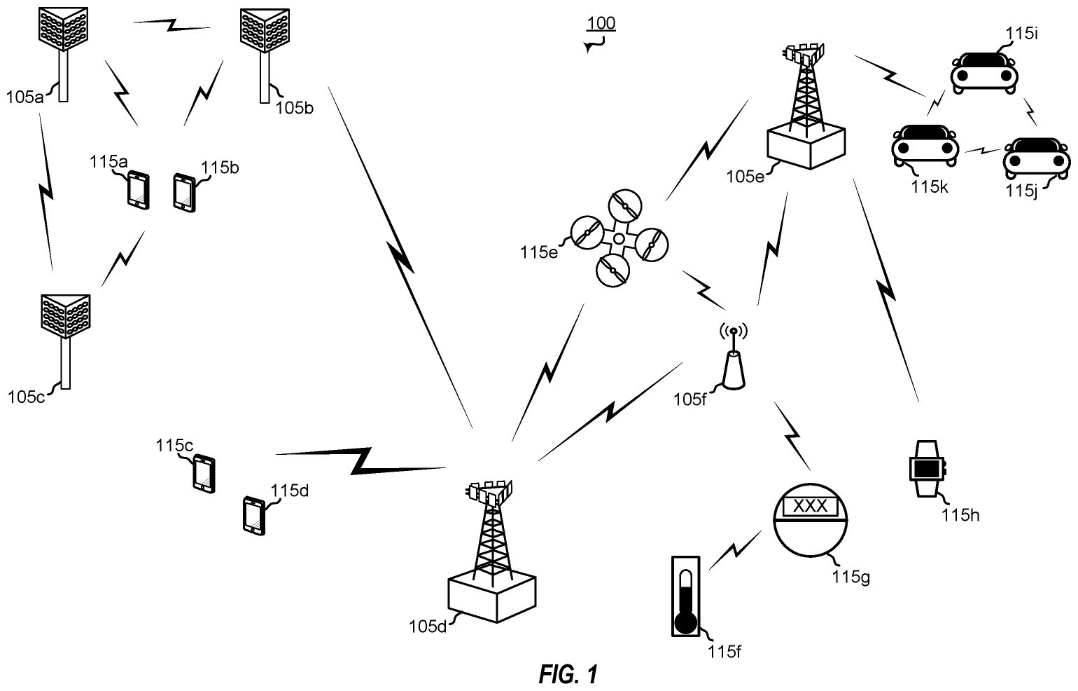

FIG. 1 is a block diagram illustrating 5G network 100 including various base stations and UEs configured according to aspects of the present disclosure. The 5G network 100 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, the base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

The 5G network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time.

The UEs 115 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE may be a device that includes a Universal Integrated Circuit Card (UICC). In another aspect, a UE may be a device that does not include a UICC. In some aspects, UEs that do not include UICCs may also be referred to as internet of everything (IoE) or internet of things (IoT) devices. UEs 115a-115d are examples of mobile smart phone-type devices accessing 5G network 100 A UE may also be a machine specifically configured for connected communication, including machine type communication (MTC), enhanced MTC (eMTC), narrowband IoT (NB-IoT) and the like. UEs 115e-115k are examples of various machines configured for communication that access 5G network 100. A UE may be able to communicate with any type of the base stations, whether macro base station, small cell, or the like. In FIG. 1, a lightning bolt (e.g., communication links) indicates wireless transmissions between a UE and a serving base station, which is a base station designated to serve the UE on the downlink and/or uplink, or desired transmission between base stations, and backhaul transmissions between base stations.

In operation at 5G network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

5G network 100 also support mission critical communications with ultra-reliable and redundant links for mission critical devices, such UE 115e. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through 5G network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. 5G network 100 may also provide additional network efficiency through dynamic, low-latency TDD/FDD communications, such as in a vehicle-to-vehicle (V2V) mesh network between UEs 115i-115k communicating with macro base station 105e.

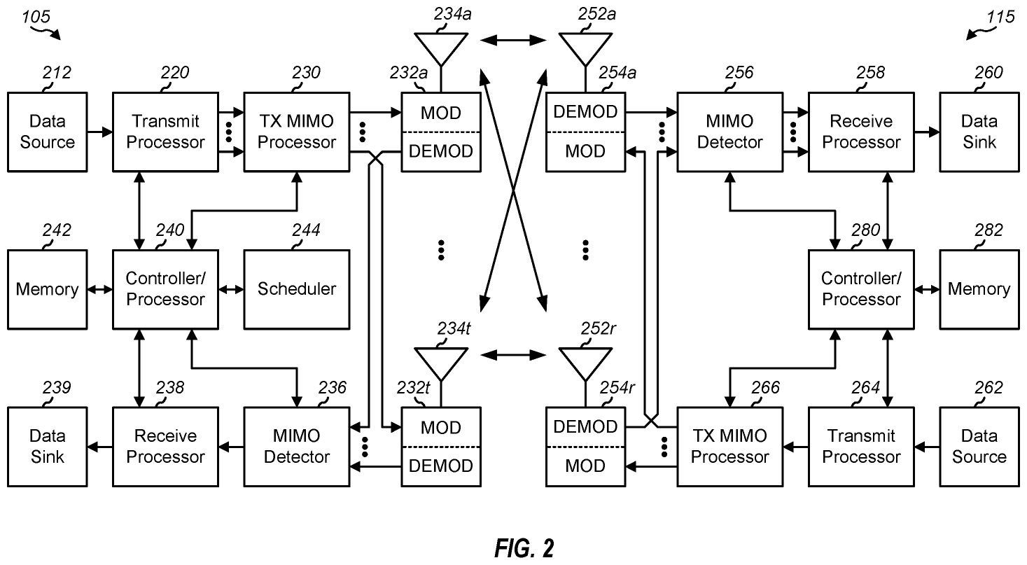

FIG. 2 shows a block diagram of a design of a base station 105 and a UE 115, which may be one of the base station and one of the UEs in FIG. 1. At the base station 105, a transmit processor 220 may receive data from a data source 212 and control information from a controller/processor 240. The control information may be for the PBCH, PCFICH, PHICH, PDCCH, EPDCCH, MPDCCH etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 105. At the base station 105, the uplink signals from the UE 115 may be received by the antennas 234, processed by the demodulators 232, detected by a MIMO detector 236 if applicable, and further processed by a receive processor 238 to obtain decoded data and control information sent by the UE 115. The processor 238 may provide the decoded data to a data sink 239 and the decoded control information to the controller/processor 240.

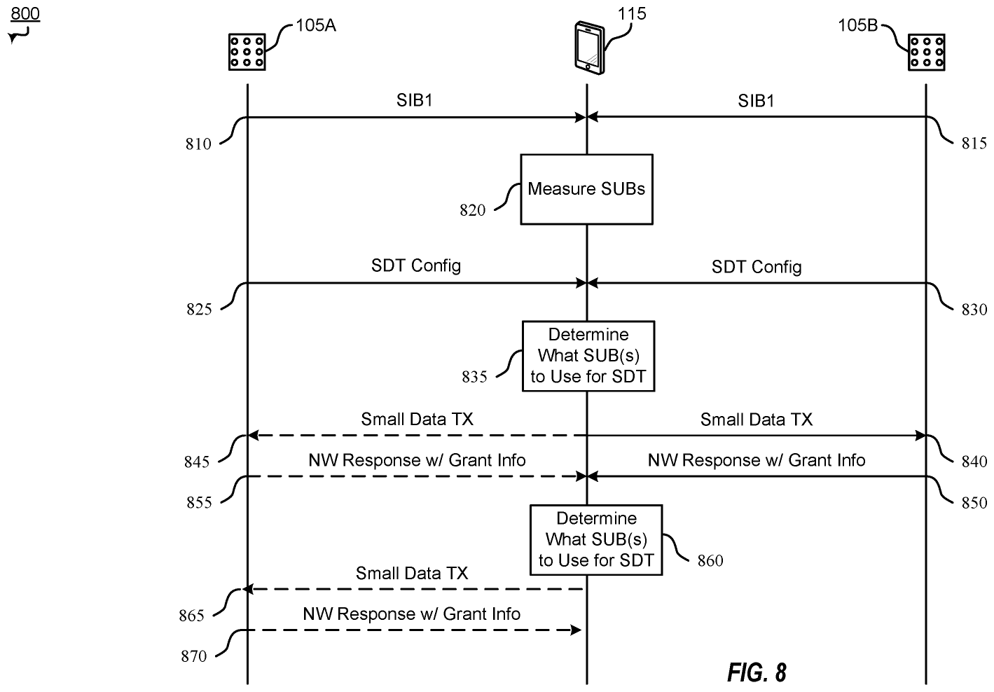

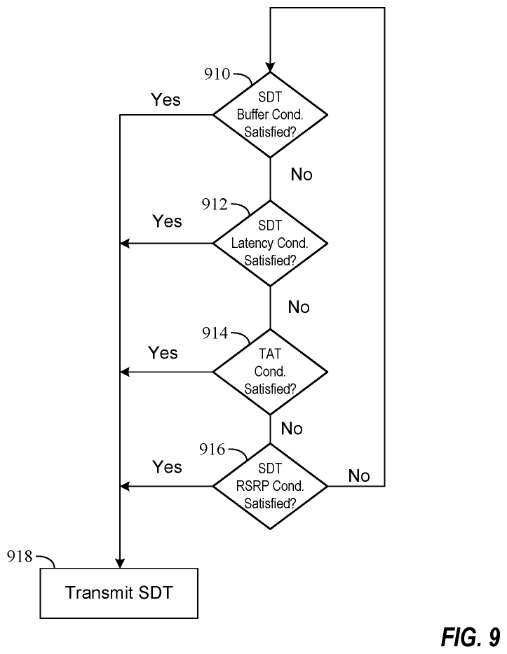

The controllers/processors 240 and 280 may direct the operation at the base station 105 and the UE 115, respectively. The controller/processor 240 and/or other processors and modules at the base station 105 may perform or direct the execution of various processes for the techniques described herein. The controllers/processor 280 and/or other processors and modules at the UE 115 may also perform or direct the execution of the functional blocks illustrated in FIGS. 7 and 8, and/or other processes for the techniques described herein. The memories 242 and 282 may store data and program codes for the base station 105 and the UE 115, respectively. A scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

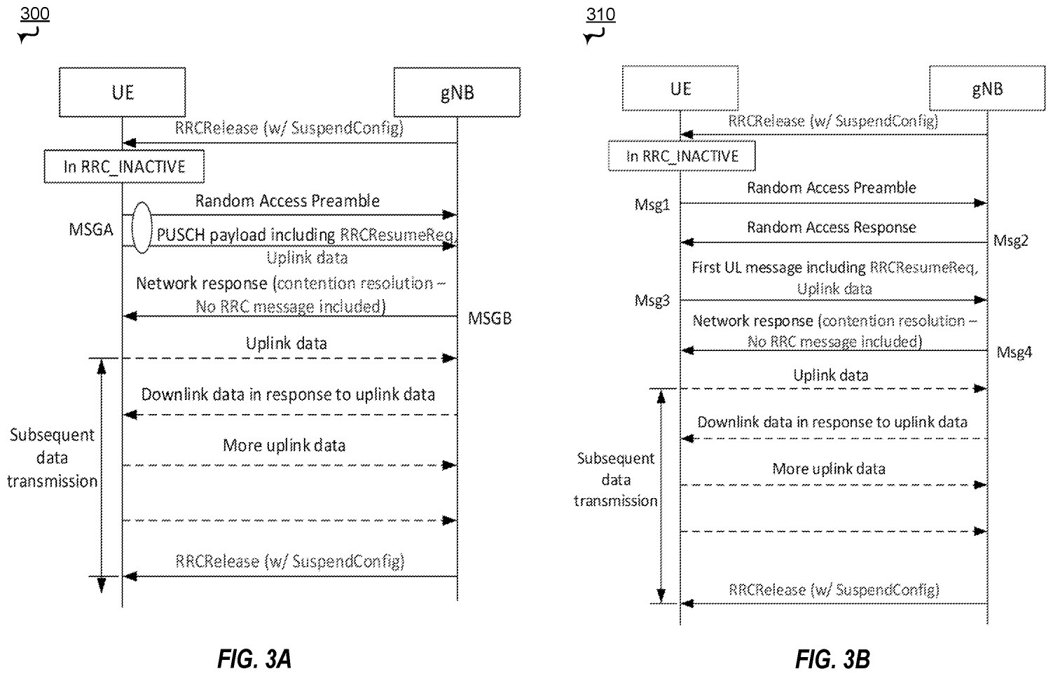

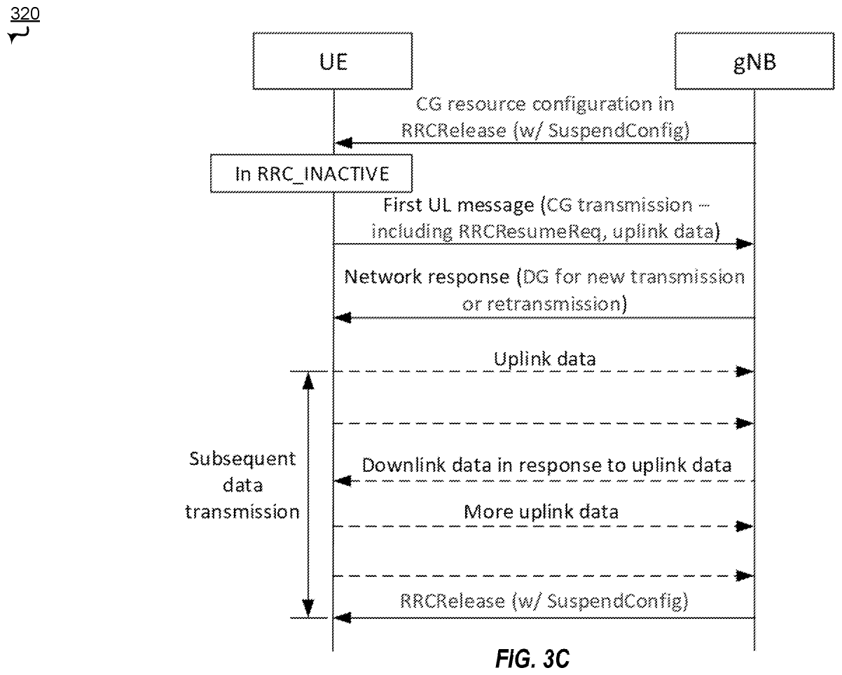

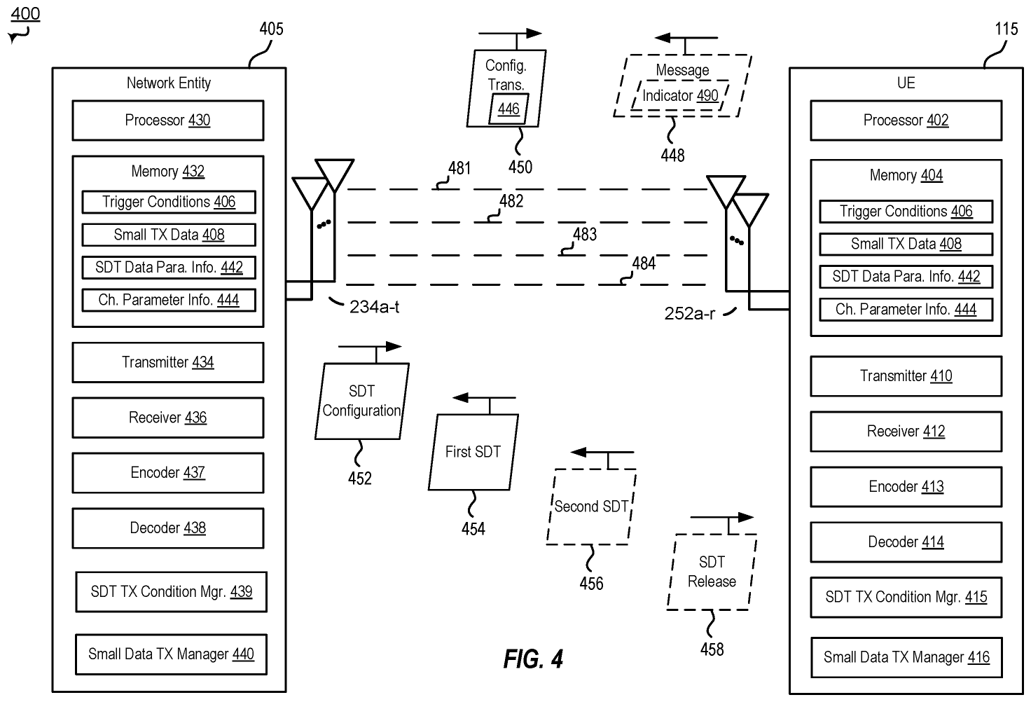

FIGS. 3A, 3B, and 3C illustrate examples of small data transmission (SDT) operations. In FIGS. 3A, 3B, and 3C, ladder diagrams 300, 310, and 320 illustrate SDT operations for two-step RACH operations, four-step RACH operations, and configured grant operations respectively.

A UE often generates only a small amount of data across a burst in a data session. This type of data traffic can occur in or across all verticals including mobile broadband (MBB) and IoT. Example of such small data bursts include data bursts for instant messing software, social media software, wearable IoT devices, and etc. It is beneficial for a network to allow a UE to transmit mobile originating (MO) uplink small data in an RRC_INACTIVE state without the UE having to move to an RRC_CONNECTED state.

For example, the network may enable transmission of uplink data on pre-configured PUSCH resources from the RRC_INACTIVE state under certain conditions, such as when time alignment (TA) value is valid. To illustrate, a TA timer (TAT) may be used to track a validity of the TA value which may indicate that the uplink timing settings are valid.

The network (e.g., eNB or gNB) configures dedicated SDT uplink resources for the UE (e.g., for a signal radio bearer (SRB) or a data radio bearer (DRB) thereof) via RRC dedicated signaling. Such signaling can occur when the UE is in an RRC_CONNECTED, RRC_IDLE, or in RRC_INACTIVE mode.

In the RRC_INACTIVE state, if the UE has small data to send and it has valid settings, such as value uplink timing settings, it can request a small data transfer or transfers without transitioning to the RRC Connected state.

The UE may then transmit the small data (i.e., small data transmission) via the SDT configuration. After the UE's transmission over the configured resource, it monitors the SDT search space for the network's response.

For NR UL small data transmission, preconfigured uplink resource can be configured to UE for subsequent uplink data transmission when the first uplink small data is transmitted via 2-step/4-step Random Access Channel (RACH) procedure. The UE receives the preconfigured uplink resource configuration and transmits subsequent UL packet in the preconfigured resource without entering RRC_CONNECTED mode. This has the benefit of power saving to keep UE in RRC_INACTIVE state for subsequent data transmission without entering RRC_CONNECTED.

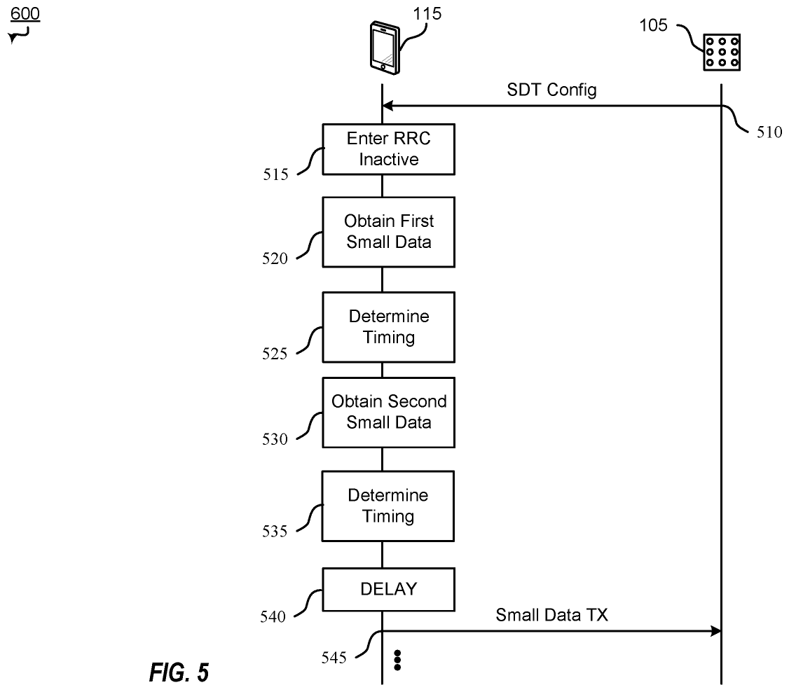

FIG. 4 illustrates an example of a wireless communications system 400 that supports enhanced SDT operations in accordance with aspects of the present disclosure. In some examples, wireless communications system 400 may implement aspects of the wireless communication system of FIG. 1 (e.g., 5G network 100). For example, wireless communications system 400 may include UE 115 and network entity 405. Enhanced SDT operations may improve bandwidth utilization and reduce power consumption and network switching by enabling a UE to send aggregated small data from, including from an RRC inactive state. The enhanced SDT operations may include conditional SDT transmission and/or data subscription select for SDT operations. Thus, network and device performance can be increased.

Network entity 405 and UE 115 may be configured to communicate via frequency bands, such as FR1 having a frequency of 410 to 7125 MHZ, FR2 having a frequency of 24250 to 52600 MHz for mm-Wave, and/or one or more other frequency bands. It is noted that SCS may be equal to 15, 30, 60, or 120 kHz for some data channels. Network entity 405 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via network entity 405 and UE 115. For example, the control information may be communicated using MAC-CE transmissions, RRC transmissions, DCI, transmissions, another transmission, or a combination thereof.

UE 115 can include a variety of components (e.g., structural, hardware components) used for carrying out one or more functions described herein. For example, these components can include processor 402, memory 404, transmitter 410, receiver 412, encoder, 413, decoder 414, SDT transmission condition manager 415, SDT manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store trigger condition data 406, small transmission data 408, SDT parameter information 442, channel parameter information 444, settings data 446, or a combination thereof, as further described herein.

The trigger condition data 406 includes or corresponds to data associated with or corresponding to SDT conditional transmission condition information. For example, the trigger condition data 406 may indicate one or more conditional trigger conditions for the transmission of small data. The trigger condition data 406 may also include thresholds, ranges, or scenarios used to evaluate the trigger conditions, such as conditions for evaluating whether or not buffered SDT should be sent. Exemplary trigger conditions for triggering the transmission of small data may include data volume or buffer conditions, data latency or delay conditions, reference signal received power (RSRP) conditions, reference signal received quality (RSRQ) conditions, received signal strength indicator (RSSI) conditions, signal-to-noise ratio (SNR) conditions, time alignment timer (TAT) conditions, small data type conditions, or a combination thereof.

The small transmission data 408 includes or corresponds to data that is associated with small data transmissions. The small transmission data 408 may include short and/or small bursts of data for MBB and IoT applications, such as data for instant messaging application, social media applications, wearable devices (e.g., fitness trackers and monitors), etc. The small transmission data 408 may include data with less than a threshold number of bytes, such as less than 10 bytes or less than 32000 bytes.

The SDT parameter information 442 includes or corresponds to data associated with or corresponding to SDT parameters, such as SDT parameter relevant to conditional transmission conditions. For example, the SDT parameter information 442 may indicate parameter information for the small data and relevant to the trigger condition data 406. Exemplary SDT parameter may include SDT data volume amount or SDT buffer amount, SDT data latency value or delay value, a type of the SDT, RSRP of a SDT, etc. To illustrate, each particular piece of small data may have information indicating a corresponding amount of the small data, and associated information (maximum delay, maximum SDT amount, priority level, etc.) which can be used to determine how to group the small data with other small data and when to send the small data.

The channel parameter information 444 includes or corresponds to data associated with or corresponding to a channel or communication link of the device, such as channel parameters that are relevant to SDT conditional transmission conditions. For example, the channel parameter information 444 may indicate parameter information for the channel or communication link and relevant to the trigger condition data 406. Exemplary channel or link parameters may include a RSRP of a channel or link, a RSRP difference of a channel or link, a TAT, or a combination thereof.

The settings data 446 includes or corresponds to data associated with SDT conditional transmissions operations. The settings data 446 may include one or more types of SDT conditional transmission operation modes and/or thresholds or conditions for switching between SDT conditional transmission modes and/or configurations. For example, the settings data 446 may have data indicating different thresholds for different SDT conditional transmission modes, such as single data subscription, dual data subscription, etc.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmissions, such as small data transmission. The SDT transmission condition manager 415 may be configured to determine and perform conditional transmission of small data operations, such as determination and evaluation of conditional transmission or trigger conditions. For example, the SDT transmission condition manager 415 is configured to determine which SDT conditional transmission conditions to use and to evaluate the SDT conditions.

The SDT manager 416 may be configured to determine and perform small data transmission management operations. For example, small data transmission manager 416 may be configured to determine data for small data transmissions and to generate small data transmissions. As another example, the SDT manager 416 is configured to perform SDT operations with multiple data subscriptions. For example, the SDT manager 416 may determine which data subscription or subscriptions to select for SDT operations.

Network entity 405 includes processor 430, memory 432, transmitter 434, receiver 436, encoder 437, decoder 438, SDT transmission condition manager 439, SDT manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store trigger condition data 406, small transmission data 408, SDT parameter information 442, channel parameter information 444, settings data 446, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, network entity 405 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of network entity 405 described with reference to FIG. 2.

Encoder 437, and decoder 438 may include the same functionality as described with reference to encoder 413 and decoder 414, respectively. SDT transmission condition manager 439 may include similar functionality as described with reference to SDT transmission condition manager 415. SDT manager 440 may include similar functionality as described with reference to SDT manager 416.

During operation of wireless communications system 400, network entity 405 may determine that UE 115 has enhanced SDT capabilities, such as conditional transmission of SDT. For example, UE 115 may transmit a message 448 that includes a conditional transmission SDT indicator 490 (e.g., a SDT conditional transmission indicator). Indicator 490 may indicate conditional transmission SDT capability or a particular type or mode of conditional transmission SDT operation. In some implementations, network entity 405 sends control information to indicate to UE 115 that conditional transmission SDT operation and/or a particular type of conditional transmission SDT operation is to be used. For example, in some implementations, message 448 (or another message, such as configuration transmission 450) is transmitted by the network entity 405. The configuration transmission 450 may include or indicate to use conditional transmission SDT operations or to adjust or implement a setting of a particular type of conditional transmission SDT operation.

During enhanced SDT operation, devices of wireless communications system 400 perform conditional transmission of small data based on the satisfaction of one or more conditions configured by the network or determined by the UE 115. For example, the network entity 405 and the UE 115 may exchange transmissions to set a particular SDT configuration. Such transmissions may include or correspond to RRC transmissions as illustrated in FIGS. 3A-3C. In the example of FIG. 4, the network entity 405 transmits a SDT configuration transmission 452 with SDT configuration information. To illustrate, a base station transmits a RRC release message with suspend configuration information that includes SDT configuration information. Additionally, or alternatively, the base station may transmit a SIB1 message with the SDT configuration information or with additional SDT configuration information, such as setting data 446. The SDT configuration information may indicate the trigger condition data 406, such as which conditions to use for conditional transmission of small data, and optionally the corresponding thresholds.

The UE 115 may perform enhanced SDT transmission operations, such as conditional transmission of small data, based on the received SDT configuration information. For example, the UE 115 may transmit one or more SDT transmissions responsive to a SDT transmit condition being satisfied, such as first SDT transmission 454 and/or second SDT transmission 456. The first SDT transmission 454 may include or correspond to a first SDT transmission after receiving the SDT configuration transmission 452, such as an SDT transmission sent while in an inactive mode or unconnected mode (e.g., RRC INACTIVE), and the second SDT transmission 456 may include or correspond to a subsequent SDT transmission sent after the first SDT transmission 454 and after synchronization (e.g., resynchronization) with the network in a RACH procedure, and sent while in the inactive mode or the unconnected mode (e.g., RRC INACTIVE).

Either the first SDT transmission 454, the second SDT transmission 456, or both, may be a conditional SDT sent responsive to determination of a trigger condition being satisfied. The first SDT transmission 454 and the second SDT transmission 456 may correspond to a same data subscription or a different data subscription. In some implementations, the UE 115 may transmit additional SDT transmissions with or without conditional transmission and on a same or different data subscription, as further described herein.

After the transmission of one or more SDTs, the network may release the SDT configuration or the SDT configuration may expire. In the example of FIG. 4, the network entity 405 transmits a SDT release transmission 458 including an SDT configuration release indication to release the SDT configuration at the UE 115. To illustrate, the network entity 405 may transmit a RRC release message with suspend configuration information which releases the previous SDT configuration and any corresponding SDT grants. In some such implementation, the RRC release message, such as the suspend configuration information thereof, includes second SDT configuration information which is configured to replace the original SDT configuration information and prior SDT configuration.

Alternatively, the SDT configuration may expire responsive to expiration of a TAT or a drop in RSRP, as further described herein, and the UE 115 may have to synchronize (resynchronize) with the network to get updated TAT information for continued SDT transmissions. After resynchronization with the network and revalidation of the TAT, the UE 115 may continue to transmit SDTs and operate with the previous SDT configuration information. Thus, the wireless communication system 400 may enable optimized SDT transmissions where the UE 115 can transmit multiple pieces of small data in a single SDT transmission subject to one or more conditions being satisfied.

During the above operations, the UE 115 may remain in a RRC inactive mode. In other implementations, the UE 115 may determine to switch a RRC connected mode to perform small data transmissions, such as when additional SDT grants are needed. In some such implementations, the UE 115 may perform RACH operations to send small data. For example, if the UE 115 does not receive a dynamic grant (establishing a SDT configuration) the UE 115 may perform RACH operations and send data during one or more of the RACH messages. To illustrate, in a two-step RACH procedure the UE 115 may send data (e.g., small data) during or with MessageA or may send data (e.g., small data) during or with Message3 for a four-step RACH procedure.

Accordingly, the UE 115 and network entity 405 may be able to more efficiently perform small data transmissions by grouping small data together for transmission reducing power consumption and wasted network bandwidth. Thus, FIG. 4 describes enhanced conditional transmission of small data operations. Using conditional transmission of small data operations may enable efficiency improvements, such as power and/or bandwidth conservation. Performing enhanced conditional transmission of small data operations enables reduced bandwidth/spectrum waste when performing small data transmissions and thus, enhanced UE and network performance by increasing throughput and reducing latency for other devices and the network as a whole.

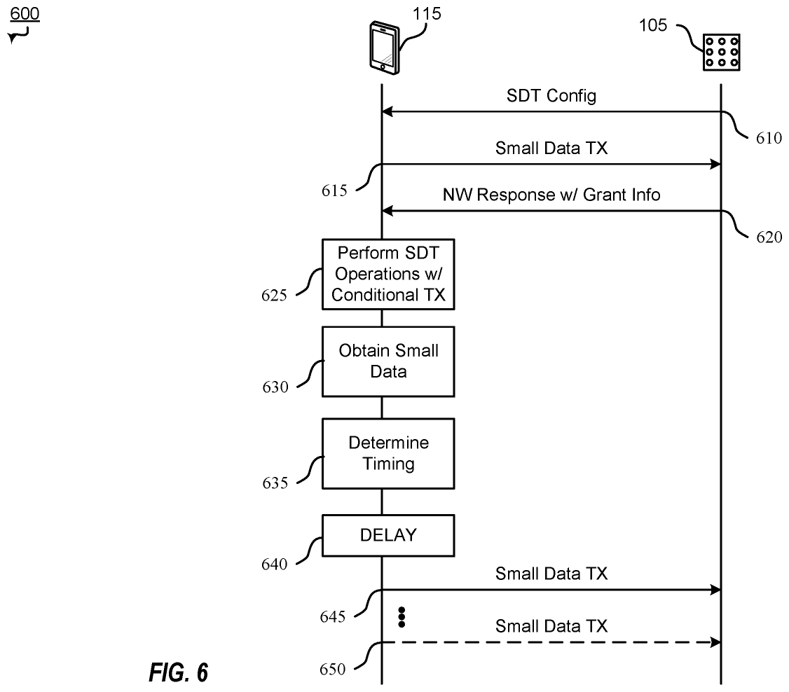

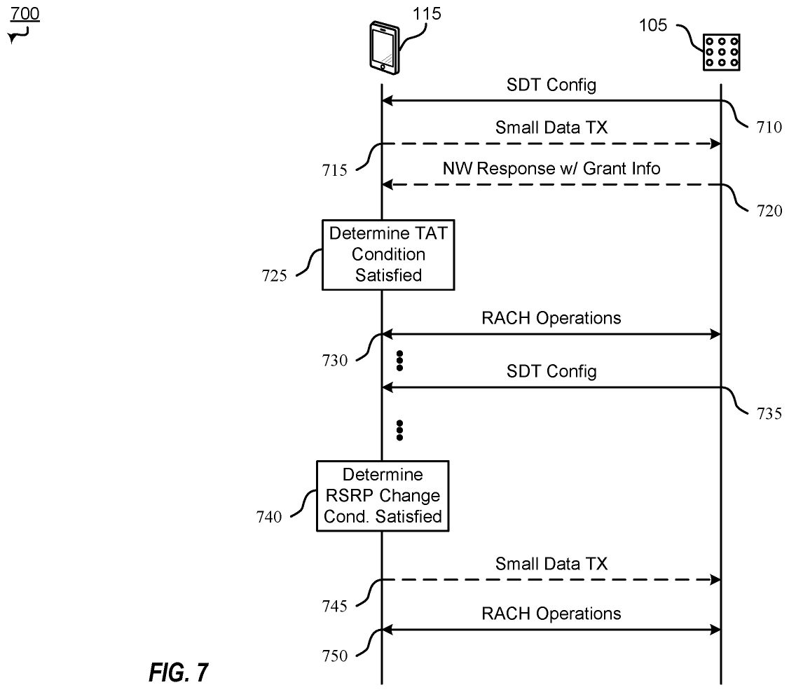

FIGS. 5-8 illustrate examples of ladder diagrams for enhanced SDT operations. Referring to FIG. 5, FIG. 5 is a ladder diagram 500 of conditional transmission of a SDT for a first SDT transmission after receiving SDT configuration information and entering a RRC INACTIVE state. In the example of FIG. 5, the ladder diagram illustrates a UE and a network entity, such as network entity 405 (e.g., base station 105). Referring to FIG. 6, FIG. 6 is a ladder diagram 600 for conditional transmission of a SDT for a subsequent (e.g., second) SDT transmission after receiving SDT configuration information and entering a RRC INACTIVE state. In the example of FIG. 6, the ladder diagram illustrates a UE and a network entity, such as base station 105. Referring to FIG. 7, FIG. 7 is a ladder diagram 700 illustrating TAT condition and RSRP condition related enhanced SDT operations. In the example of FIG. 7, the ladder diagram illustrates a UE and a network entity, such as base station 105. Referring to FIG. 8, FIG. 8 is a ladder diagram 800 for enhanced SDT operations for dual subscriptions. In the example of FIG. 8, the ladder diagram illustrates a UE and two network entities, such as base station 105A and base station 105B.

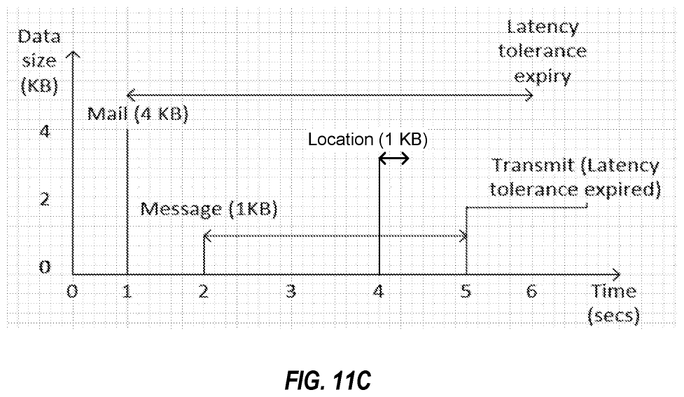

Referring to FIGS. 5-6, conditional transmit SDT operations are illustrated. For example, in FIG. 5, a device performs conditional transmission of small data for a first SDT transmission, and in FIG. 6 a device performs conditional transmission of small data for a second, subsequent SDT transmission. In the examples of FIGS. 5 and 6, the device may obtain (receive or generate) multiple different types and/or pieces for small data, and the device may refrain from sending the small data until one or more conditions are met. The conditional transmission of small data, by SDT, may enable devices to perform less RACH operations, spend more time in RRC inactive, and send less SDTs, and send SDTs with higher bandwidth utilization (e.g., more data more often). The SDT transmissions in FIGS. 5 and 6 may include or correspond to the first and second SDT transmission of FIGS. 3A-3C. Additionally, illustrative scenarios are also provided in FIGS. 11A-11C to provide examples of combining small data for SDT and example SDT transmission conditions.

In the example of FIG. 5, the devices may engage in conditional transmission of small data operations for a first SDT after receiving SDT configuration. During operations, the UE 115 receives SDT configuration information from a base station 105 at 510. For example, the UE 115 may receive a RRC release with suspend configuration information, which include SDT configuration information.

At 515, the UE 115 may optionally enter a RRC inactive state responsive to the receiving the SDT configuration information. For example, when the UE 115 receives the SDT configuration information from the base station 105 in a RRC release message and/or with suspend configuration information, the UE 115 may transition to the RRC inactive state, such as switch from RRC connected to RRC inactive.

At 520, the UE 115 receives first small data. For example, the UE 115 may receive a first small data packet into a small data buffer for SDT at a first time. The first small data may have a particular type, such as mail, message, location, IoT, MBB, etc. The first small data may be generated by the UE 115 or obtained by the UE 115 from another communication link and device, such as not from the base station 105.

At 525, the UE 115 determines a SDT latency condition for the first small data. For example, the UE 115 may determine a time or SDT TXOP to transmit the first small data if no other SDT conditional transmission conditions are satisfied before that time. To illustrate, the UE 115 may determine a second time which is X amount of time after a first time where the first small data is received or placed into the buffer.

At 530, the UE 115 receives second small data. The second small data may have a particular type, such as mail, message, location, IoT, MBB, etc., and the type of the second small data may be the same as or different from the particular type of the first small data. The second small data is distinct from the first small data, such as corresponds to a different small data message. The second small data may be generated by the UE 115 or obtained by the UE 115 from another communication link and device, such as not from the base station 105.

At 535, the UE 115 determines a SDT latency condition for the second small data. For example, the UE 115 may determine a time or SDT TXOP to transmit the second small data in if no other SDT conditional transmission conditions are satisfied before that time. To illustrate, the UE 115 may determine a fourth time which is X amount of time after a third time where the second small data is received or placed into the buffer.

At 540, the UE 115 determines to delay one or more SDT TXOPs. For example, the UE 115 determines to refrain from transmitting the received small data in a first SDT TXOP, and optionally one or more subsequent SDT TXOPs therefrom, based on no SDT conditional transmission condition being satisfied.

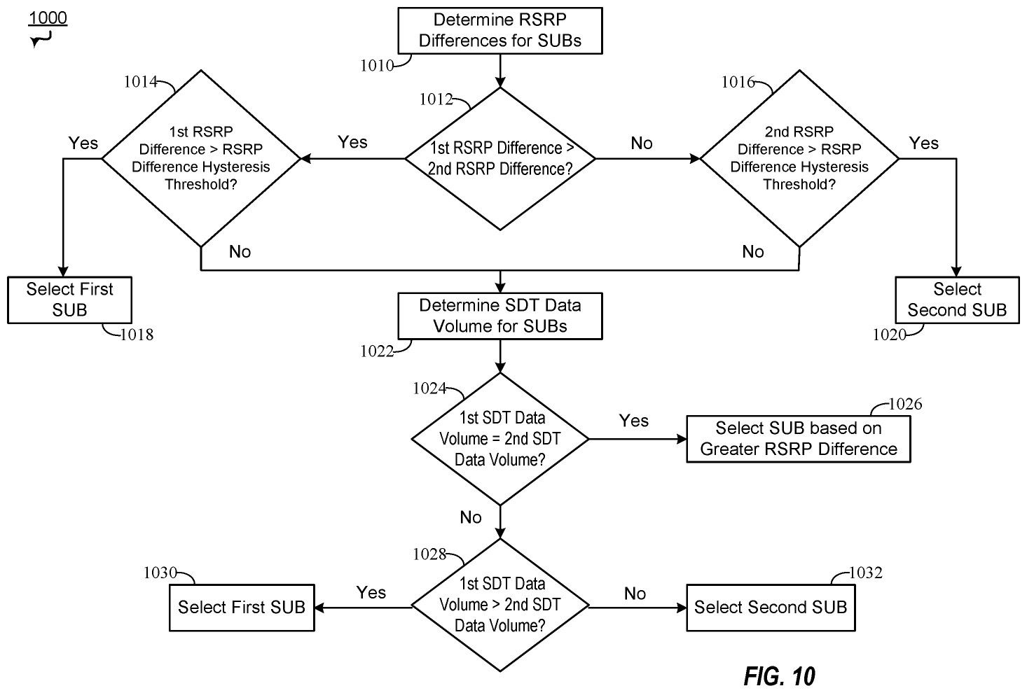

At 545, the UE 115 determines one or more SDT conditional transmission conditions have been satisfied, and the UE 115 transmits a SDT including the first and second small data. For example, the UE 115 may determine that a first latency condition associated with the first small data or that a second latency condition associated with the second small data has been satisfied. The UE 115 may proceed to combining the two pieces of small data into a single SDT for transmission. Examples of evaluating conditional SDT transmission conditions are described further with reference to FIG. 9, and examples of SDT transmission are described further with reference to FIGS. 11A-11C.

After 545, the UE 115 may continue to transmit SDTs based on the received SDT configuration information at 510, and optionally based on configured grant information or dynamic grant indication from the base station 105, as described further with reference to FIG. 6. The transmission of additional SDTs may include performance of one or more operations as described with reference to 630-645, and optionally may include performance of RACH operations or a request for configured grants to secure additional TXOPs or time for SDT operations. For example, the device may transmit second SDTs as illustrated in FIGS. 3A-4 subsequent to performance of RACH operations and/or receipt of configured grant information.

Referring to FIG. 6, in the example of FIG. 6 the devices may engage in conditional transmission of small data operations for a subsequent SDT after transmitting a first SDT based on a received SDT configuration. During operations, the UE 115 receives SDT configuration information from a base station 105 at 610. For example, the UE 115 may receive a RRC release with suspend configuration information, which includes SDT configuration information.

At 615, the UE 115 may optionally transmit an SDT. For example, the UE 115 may engage in conditional SDT transmission as in FIGS. 4 and 5, and may perform one or more of the operations of FIGS. 4 and/or 5. To illustrate, the device may perform one or more operations as described with reference to FIG. 4 or with reference to 515-545 of FIG. 5. As another example, the UE 115 may perform conventional SDT operations as in any of FIGS. 3A-3C.

At 620, the network may transmit a response to the SDT. For example, the base station 105 may transmit a RACH message with grant information to the UE 115 responsive to and/or based on the SDT. To illustrate, the first SDT may include RACH information and/or may be part of a RACH request or process, such as a two or four-step RACH process in FIG. 3A or FIG. 3B. In some such implementations, the base station 105 may respond with grant information (e.g., CG and/or SDT grant information) for future SDT operations, as in FIG. 3C. In some other such implementations, the grant information is included in a RRC release message or with SDT configuration information.

At 625, the UE 115 performs SDT operations based on the SDT configuration received at 610 or based on an updated SDT configuration or SDT grant information received at 620. For example, the UE 115 optionally remains in or transitions to a non-connected state for SDT operations (e.g., RRC INACTIVE) using the SDT configuration received at 610 or the updated SDT configuration received at 620.

At 630, the UE 115 receives first small data. For example, the UE 115 may receive a first small data packet into a small data buffer for SDT at a first time. The first small data may have a particular type, such as mail, message, location, IoT, MBB, etc. The first small data may be generated by the UE 115 or obtained by the UE 115 from another communication link and device, such as not from the base station 105.

At 635, the UE 115 determines a SDT latency condition for the first small data. For example, the UE 115 may determine a time or SDT TXOP to transmit the first small data in if no other SDT conditional transmission conditions are satisfied before that time. To illustrate, the UE 115 may determine a second time which is X amount of time after a first time where the first small data is received or placed into the buffer.

Similar to the example of FIG. 5, the UE 115 may receive second small data in some implementations. The second small data may have a particular type, such as mail, message, location, IoT, MBB, etc., and the type of the second small data may be the same as or different from the particular type of the first small data. The second small data is distinct from the first small data, such as corresponds to a different small data message. The second small data may be generated by the UE 115 or obtained by the UE 115 from another communication link and device, such as not from the base station 105.

The UE 115 may determine a SDT latency condition for the second small data. For example, the UE 115 may determine a time or SDT TXOP to transmit the second small data in if no other SDT conditional transmission conditions are satisfied before that time. To illustrate, the UE 115 may determine a fourth time which is X amount of time after a third time where the second small data is received or placed into the buffer.

At 640, the UE 115 determines to delay one or more SDT TXOPs. For example, the UE 115 determines to refrain from transmitting the received small data in a first SDT TXOP and optionally one or more subsequent SDT TXOPs therefrom based on no SDT conditional transmission condition being satisfied.

At 645, the UE 115 determines one or more SDT conditional transmission conditions have been satisfied, and the UE 115 transmits a SDT including the first small data, and optionally including the second small data. For example, the UE 115 may determine that a first latency condition associated with the first small data or that a second latency condition associated with the second small data has been satisfied. The UE 115 may proceed to combining the two pieces of small data into a single SDT for transmission. Examples of evaluating conditional SDT transmission conditions are described further with reference to FIG. 9, and examples of SDT transmission scenarios are described further with reference to FIGS. 11A-11C.

The UE 115 may continue to transmit SDTs based on the received grant information at 650. The transmission of additional SDTs may include performance of one or more operations as described with reference to 630-645, and optionally may include performance of RACH operations or a request for configured grants to secure additional TXOPs or time for SDT operations.

Referring to FIG. 7, conditional SDT operations for a TA timer condition and a RSRP change are illustrated. For example, in FIG. 7, a device may determine to perform RACH operations to refresh its TA timer in response to expiration of the TA timer. Expiration of the TA timer may include a determination that no SDT transmit opportunities are available inside the remaining TA timer valid time and/or that a SDT transmit opportunity cannot be obtained with the TA timer remaining valid time. Additionally, or alternatively, the device may determine to send any obtained SDT in the buffer and perform a RACH operation responsive to determination that the RSRP of the link/subscription is changing (e.g., deteriorating) at a certain rate, likely to surpass a RSRP threshold associated with the link/subscription, or both.

In the example of FIG. 7, the devices may engage in conditional transmission of small data operations for TA timer and RSRP. During operation, the UE 115 receives SDT configuration information from a base station 105 at 710. For example, the UE 115 may receive a RRC release message with suspend configuration information, which includes SDT configuration information.

At 715, the UE 115 may optionally transmit an SDT. For example, the UE 115 may engage in conditional SDT transmission as in FIGS. 4 and 5, and may perform one or more of the operations of FIGS. 4 and/or 5 to transmit a SDT based on one or more transmission conditions. To illustrate, the device may perform one or more operations as described with reference to FIG. 4 or to 515-555 of FIG. 5. As another example, the UE 115 may perform conventional SDT operations as in any of FIGS. 3A-3C.

At 720, the network may transmit a response to the SDT. For example, the base station 105 may transmit a RACH message (e.g., RACH response) with grant information to the UE 115 responsive to and/or based on the SDT. To illustrate, the first SDT may include RACH information and/or may be part of a RACH request or process, such as the two-step RACH of FIG. 3A or the four-step RACH of FIG. 3B. In some such implementations, the base station 105 may respond with grant information (e.g., CG and/or SDT grant information) for future SDT operations. In some other such implementations, the grant information is included in a RRC release message or with SDT configuration information.

At 725, the UE 115 may determine whether a TA timer condition is satisfied. For example, the UE 115 may determine a TA timer value and a TA timer threshold. The UE 115 may compare the determined TA timer value to the TA timer threshold to determine whether the TA timer condition is satisfied, as further described with reference to FIG. 9.

After 725, the UE 115 may determine that the TA timer condition has been satisfied, and the UE 115 transmits a SDT including first small data, and optionally including second small data. To illustrate, the UE 115 may transmit any remaining SDT in the buffer prior to or in response to expiration of the TA timer. Examples of evaluating a TA timer condition are described further with reference to FIG. 9.

At 730, the UE 115 and base station 105 perform RACH operations. For example, when the TA timer has expired, the UE 115 may initiate a RACH operation to get synchronized (e.g., resynchronized) with the network and optionally to send small data based on the SDT configuration received. To illustrate, the UE 115 may transmit a RACH message with a SDT, such as including the first small data at 725 as part of the RACH message of a 2 or 4-step RACH operation. The UE 115 may receive a RACH response message from the base station 105 with information (e.g., an indication) to reset its TA timer to synchronize with the network. Additionally, or alternatively, the UE 115 may receive a new or updated SDT configuration (SDT configuration information) as part of the RACH operations at 730 or after performance of the RACH operations at 735. For example, the new SDT configuration may be received by the UE 115 in a last RACH response message at 730 or in a RRC release message at 735 following completion of the RACH operation at 730.

At 740, the UE 115 may determine whether a RSRP change (e.g., RSRP delta) condition is satisfied. For example, the UE 115 may determine a RSRP change between two measured or estimated RSRP values for communications with the base station 105 and a RSRP change threshold. The UE 115 may compare the determined RSRP change to the RSRP change threshold to determine whether the RSRP change condition is satisfied. The RSRP change condition being satisfied may correspond to a scenario where the RSRP of the communication link is deteriorating at a high rate, such as a rate above a threshold value.

As another example, the UE 115 may use a RSRP difference condition. To illustrate, the UE 115 may determine a RSRP difference between a measured or estimated RSRP value for a communication or communications with the base station 105 and a RSRP threshold. The UE 115 may compare the determined RSRP difference to a SDT RSRP difference threshold to determine whether the RSRP difference condition is satisfied, as further described with reference to FIG. 9.

After 740, the UE 115 may determine that the RSRP change (or difference) condition has been satisfied, and the UE 115 may transmit a SDT including the first small data, and optionally including the second small data, and/or perform RACH operations. Examples of evaluating a RSRP difference condition are described further with reference to FIG. 9.

At 745, the UE 115 may transmit a SDT including the first small data, and optionally including the second small data. For example, the UE 115 may determine that the RSRP change condition has been satisfied, and the UE 115 may proceed to combining the two pieces of small data into a single SDT for transmission. To illustrate, the UE 115 may transmit any remaining SDT in the buffer prior to or in response to satisfaction of the RSRP change condition and before loss of the communication link and before RACH operations are performed to reestablish the communication link.

At 750, the UE 115 and base station 105 perform RACH operations. For example, when the RSRP change condition has been satisfied, the UE 115 may initiate a RACH operation to get synchronized (e.g., resynchronized) with the network and optionally to send small data based on the SDT configuration received. To illustrate, the UE 115 may transmit a RACH message with a SDT, such as including the first small data at 745, as part of the RACH message of a 2 or 4-step RACH operation. The UE 115 may receive a RACH response message from the base station 105 with information (e.g., an indication) to reset its TA timer to synchronize with the network. Additionally, or alternatively, the UE 115 may receive a new or updated SDT configuration (SDT configuration information) as part of the RACH operations at 750 or after performance of the RACH operations at 750. For example, the new SDT configuration may be received by the UE 115 in a last RACH response message at 750 or in a RRC release message following completion of the RACH operation at 730.

Referring to FIG. 8, FIG. 8 is a ladder diagram of another example of conditional SDT operations according to some embodiments of the present disclosure. In FIG. 8, conditional SDT operations in dual subscription operation modes is illustrated. For example, in FIG. 8, a device (e.g., UE 115) may determine to perform SDT operations for one or both subscriptions. Additionally, the device may determine to use SDT conditional transmission operations in one or more of the subscriptions. As illustrated in FIG. 8, the device may determine which subscription to use before a first SDT transmission after receiving SDT configuration information. In other examples, the device may determine which subscription to use before subsequent SDT transmissions after the first SDT transmission.

During operation, the network may transmit configuration information for enhanced SDT operations in dual data subscription modes. For example, the first base station 105A may transmit a first SIB1 message at 810 and the second base station 105 may transmit a second SIB1 message at 815. The SIB1 messages may be broadcast and received by one or more UEs, such as UE 115. The SIB1 messages may include information regarding the subscription, including SDT operations thereof. As illustrative, non-limiting examples, the SIB1 messages may include data volume threshold information, RSRP threshold information, or a combination thereof. The RSRP threshold information may include a RSRP difference threshold, a RSRP difference hysteresis threshold, or both.

At 820, the UE 115 operates with the first and second base stations 105A and 105B, and measures communications thereof to determine channel and/or communication link properties. For example, the UE 115 may measure RSRP for downlink transmissions for each data subscription.

After operation with the data subscriptions, the UE 115 may receive SDT configuration information from one or more of the data subscriptions. For example, the UE may receive first SDT configuration information from the first base station 105A at 825 and may receive second SDT configuration information from the second base station 105B at 830. The SDT configuration information may be received in a RRC release message, such as included with suspend configuration information.

After receiving SDT configuration information, the UE 115 may determine which data subscription or subscriptions to use for small data transmission at 835. For example, the UE 115 may determine to use a first data subscription associated with the first base station 105A only, a second data subscription associated with the second base station 105B only, or both data subscriptions.

In some implementations, the UE 115 determines to transmit small data via the second data subscription to the second base station 105B at 840. Additionally, or alternatively, the UE 115 determines to transmit second small data via the first data subscription to the first base station 105A at 845.

After transmission of small data, the UE 115 may receive a response from the network based on or responsive to the SDT. For example, the UE 115 may receive a response from the second base station 105B at 850, may receive a second response from the first base station 105A at 855, or both. The response may include or correspond to a RACH operation step or transmission and/or may include uplink or SDT grant information for subsequent small grants, as described with reference to FIGS. 3A-4.

In some implementations, the UE 115 may engage in continued SDT operations on one or more of the data subscriptions based on the SDTs and responses from the network at 840-855. In some such implementations, the UE 115 may optionally determine which data subscription or data subscriptions to use for additional SDTs. In the example of FIG. 8, the device may choose to use the first data subscription only for future SDTs. The device may transmit small data to the first base station 105A at 856, and receive a response at 870, similar to the operations described with reference to 840-855.

Referring to FIG. 9, FIG. 9 is a block diagram of an example of evaluating SDT transmission conditions for conditional SDT operations according to some embodiments of the present disclosure. In FIG. 9, a logic diagram or decision flow for evaluating SDT transmission conditions is disclosed. For example, FIG. 9 depicts one example where the conditions may be evaluated serially after receipt of SDT data in a SDT buffer (e.g., SDT related data or packet at the Packet Data Convergence Protocol (PDCP) layer) and satisfaction of any one condition initiates a SDT in the next SDT transmission opportunity (SDT TXOP).

In the example of FIG. 9, the SDT transmission conditions for conditional transmission of SDTs include a SDT buffer size condition, a SDT latency condition, a TA timer condition, and an SDT RSRP condition (e.g., RSRP delta or change condition). Each of the conditions may include or correspond to a threshold, a series of thresholds, or a range.

During operation, data (small data) is received into a buffer, such as a SDT buffer, for transmission via SDT. The device may delay from immediately sending the data in a next transmit opportunity, such as a next SDT TXOP, to enable the device to attempt to combine the data with other data (e.g., second small data) for transmission via SDT.

The device may begin to evaluate one or more SDT transmission conditions for conditional transmission of SDTs as illustrated in the example of FIG. 9. The device may first evaluate a SDT buffer condition at 910. For example, the device may compare an amount of small data in a small data buffer or a sum of the amount of small data in the small data buffer plus an amount of small data to be added to the small data buffer to a small data buffer threshold (or small data volume condition). If the amount of small data is greater than or equal to the small data buffer threshold, the device may determine that the SDT buffer condition is satisfied. If the amount of small data is less than the small data buffer threshold, the device may determine that the SDT buffer condition is not satisfied.

Responsive to determining that the SDT buffer condition is satisfied at 912, the device may proceed to transmitting the small data via a small data transmission at 918. The satisfaction of the SDT buffer condition may include sending all data in the SDT buffer or sending multiple different small data in the SDT buffer up to a SDT data volume limit of the network or data subscription, such as a SDT data volume specified in a SIB1 message.

Responsive to determining that the SDT buffer condition is not satisfied at 910, the device may proceed to evaluating a SDT latency condition at 912. For example, the device may determine SDT latency values for each piece of small data in the small data buffer. To illustrate, each type of small data may have a corresponding latency associated with it, such as x ms for mail small data and y ms for message small data. The device may start a timer or counter for each piece of small data when it is added to the buffer. The device may then increment or decrement the timer or counter as time elapses. The device may compare the respective timers or counters to a small data latency threshold or timer/counter value to determine if the corresponding latency amounts for the small data have or are about to lapse. If the counter or timer reaches the threshold value or zero, the device may determine that the SDT latency condition is satisfied. If the counter or timer has not reached the threshold value, the device may determine that the SDT latency condition is not satisfied.

Responsive to determining that the SDT latency condition is satisfied at 912, the device may proceed to transmitting the small data via a small data transmission at 918. The satisfaction of the SDT latency condition may include sending only the small data whose timer/counter has expired (latency expired), sending all data in the SDT buffer, or sending multiple different small data in the SDT buffer up to a SDT data volume limit of the network or data subscription, such as a SDT data volume specified in a SIB1 message, even if the corresponding timers/counters have not expired.

Responsive to determining that the SDT latency condition is not satisfied at 912, the device may proceed to evaluating a TA timer condition at 914. For example, the device may determine to set a TA timer based on TA timer configuration information from the network, and the device may use the TA timer as a conditional SDT transmission condition. To illustrate, each communication link or data subscription may have a dedicated TA timer (or counter) which is set to an indicated value and is decremented over time. The device may compare the respective TA timers or counters to a particular threshold value, such as zero or another value for a last SDT transmit opportunity before zero and the TA timer expires. If the counter or timer reaches the threshold value or zero, the device may determine that the TA timer condition is satisfied. If the counter or timer has not reached the threshold value or zero, the device may determine that the TA timer condition is not satisfied.

Responsive to determining that the TA timer condition is satisfied at 914, the device may proceed to transmitting the small data via a small data transmission at 918. The satisfaction of the TA timer condition may include sending all data in the SDT buffer or sending multiple different small data in the SDT buffer up to a SDT data volume limit of the network or data subscription, such as a SDT data volume specified in a SIB1 message.

Responsive to determining that the TA Timer condition is not satisfied at 914, the device may proceed to evaluating a SDT RSRP condition at 916. For example, the device may determine a SDT RSRP threshold value for small data transmission or multiple SDT RSRP threshold values, such as a corresponding SDT RSRP threshold value for a particular communication link or data subscription. To illustrate, each communication link may have a dedicated SDT RSRP condition. The SDT RSRP condition may be broadcast by the network device, such as in a SIB1 message. The SDT RSRP condition may include or correspond to a lowest SDT value allowed before small data in the buffer is sent and before RACH operations should be performed, a change in RSRP condition (e.g., RSRP delta condition). If the determined RSRP for the device or the communication link reaches the threshold value, the device may determine that the SDT RSRP condition is satisfied. If the determined RSRP for the device or the communication link has not reached the threshold value or zero, the device may determine that the SDT RSRP condition is not satisfied.

Responsive to determining that the SDT RSRP condition is satisfied at 916, the device may proceed to transmitting the small data via a small data transmission at 918. The satisfaction of the SDT RSRP condition may include sending all data in the SDT buffer or sending multiple different small data in the SDT buffer up to a SDT data volume limit of the network or data subscription, such as a SDT data volume specified in a SIB1 message.

Responsive to determining that the SDT RSRP condition is not satisfied at 916, the device may proceed back to evaluating (e.g., reevaluating) the SDT buffer condition at 910. The device may then proceed through the process until a condition is satisfied and the small data in the buffer is transmitted.

Although the conditions are illustrated as being evaluated serially in the example of FIG. 9, the SDT transmission conditions may be evaluated in parallel and evaluated responsive to a trigger in other implementations. For example, the buffer size condition may be evaluated whenever data is added to or placed into the buffer. As another example, the latency and TA timer conditions may be evaluated each time the respective timer or counter changes. As yet another example, the RSRP condition may be evaluated responsive to the respective RSRP values changing, such as responsive to an RSRP value for a particular transmission being determined.

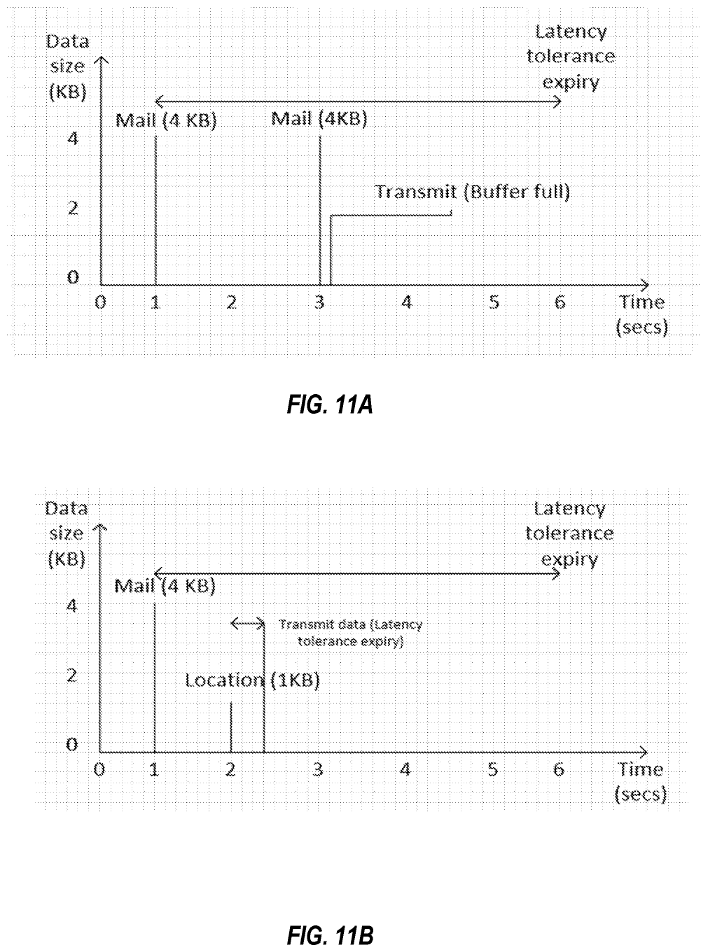

Referring to FIG. 10, FIG. 10 is a block diagram of an example of evaluating subscriptions for conditional SDT operations in dual subscription modes according to some embodiments of the present disclosure. In FIG. 10, a logic diagram or decision flow for evaluating subscriptions for SDT operations, including conditional transmission of small data, is disclosed. For example, FIG. 10 depicts one example where two subscriptions of a device operating in a dual sim dual active (DSDA) mode are configured for SDT operations. In some such DSDA modes, the device may determine which subscription or subscriptions to use for SDT operations, including for SDT operations with conditional transmission. Alternatively, the device may utilize both subscriptions for SDT operations.

In the example of FIG. 10, the device uses RSRP difference and SDT data volume information and conditions to select a particular subscription for conditional transmission of small data. RSRP difference corresponds to a difference between an RSRP threshold associated with the subscription, such as from a SIB1 message and/or the SDT settings, and a measured RSRP for the subscription. The RSRP threshold may be advertised by the subscription, such as a base station or serving cell of the device, and/or provide with the SDT configuration information, such as in the SuspendConfig IE of the RRC Release message. To illustrate, the SDT config IE may indicate the RSRP threshold. The RSRP measured value may include or correspond to a last or average RSRP value associated with transmission(s) for the subscription.

The SDT data volume corresponds to a SDT data volume setting associated with the subscription, such as from a SIB1 message and/or the SDT settings. The SDT data volume may be advertised by the subscription, such as a base station or serving cell of the device, and/or provided with the SDT configuration information, such as in the SuspendConfig IE of the RRC Release message. To illustrate, the SDT config IE may indicate the SDT data volume threshold.

In FIG. 10, the subscription selection flow first attempts to make a determination based on RSRP difference, such as the subscription with the highest RSRP difference and also which satisfies a RSRP difference hysteresis threshold. For example, if the largest RSRP difference is not larger than a hysteresis condition/threshold, the device will attempt to use data volume instead of RSRP difference to select the subscription for SDT operations. If the largest RSRP difference does satisfy the hysteresis condition/threshold, the device will make the selection of the SDT subscription based on RSRP difference alone and independent of data volume.

In scenarios where data volume is used to select the subscription for SDT operations, the device may select the subscription with the larger data volume capacity (e.g., highest data volume threshold). As illustrated in the example of FIG. 10, the device may also utilize another condition or revert back to RSRP difference when the data volume condition/capacity is the same for both subscriptions. In this manner, the device can still prioritize the slightly better performing subscription based on RSRP difference even if it did not satisfy the RSRP difference hysteresis condition when the data volume condition/capacity is the same for both subscriptions.

During operation, data (small data) is received into a buffer, such as a SDT buffer, for transmission via SDT. The device may delay from immediately sending the data in a next transmit opportunity, such as a next SDT TXOP, to enable the device to attempt to combine the data with other data (e.g., second small data) for transmission via SDT in a subsequent SDT TXOP.

The device may begin to evaluate one or more SDT data subscriptions or communication links for selection of data subscription (data SUB) for conditional transmission of SDTs as illustrated in the example of FIG. 10. The device may first determine RSRP differences for both data subscriptions at 1010. For example, the device may determine a RSRP for both data subscriptions and determine a corresponding RSRP threshold for both data subscriptions to determine a RSRP difference for each data subscription. To illustrate, the device may determine a first RSRP threshold for a first data subscription based on a first SIB1 message associated with first data subscription and may determine a second RSRP threshold for a second data subscription based on a second SIB1 message associated with second data subscription. The device may also determine a first RSRP associated with the first data subscription and a second RSRP associated with the second RSRP subscription. As illustrative examples, the RSRP for each data subscription may include or correspond to an average RSRP for communications associated with the data subscription or a last RSRP for a most recent communication associated with the data subscription. The device may then determine an RSRP difference for each data subscription by determining a difference between the RSRP threshold for the data subscription and the measured or determined RSRP for the data subscription. For example, the device may determine a first RSRP difference value by subtracting the RSRP threshold from the determined RSRP, or vice versa.

After determining the RSRP differences for both data subscriptions at 1010, the device may proceed to evaluating the RSRP differences at 1012 to determine which is greater. For example, the device may determine if the first RSRP difference associated with the first data subscription is greater than the second RSRP difference associated with the second data subscription at 1012.

Responsive to determining that the first RSRP difference associated with the first data subscription is greater than the second RSRP difference associated with the second data subscription at 1012, the device may proceed to evaluating the first RSRP difference against a RSRP difference hysteresis condition at 1014. For example, the device may determine or receive a RSRP difference hysteresis threshold (e.g., internally based on preconfiguration or externally from SIB1 or SDT config IE), which is used to ensure that difference between the first and second RSRP differences is great enough to select a data subscription based on RSRP difference (e.g., RSRP difference alone). To illustrate, when the difference between the RSRP difference and the hysteresis threshold is small, selecting the data subscription based on another parameter, such as data volume in the example of FIG. 10, may offer improved performance as compared to selecting a data subscription with slightly or marginally better RSRP difference, which may ultimately be the data subscription with a lower measured/determined RSRP.

After the device determines the RSRP difference hysteresis threshold, the device compares the first RSRP difference associated with the first data subscription to the RSRP difference hysteresis threshold to determine if the first RSRP difference is greater than the RSRP hysteresis threshold. If the first RSRP difference is greater than the RSRP hysteresis threshold, the device may determine that the RSRP difference hysteresis condition is satisfied and the device selects, at 1018 and based on the higher RSRP difference, the first data subscription for SDT operations, such as enhanced SDT operations with conditional transmission. If the first RSRP difference is not greater than (e.g., less than or equal to) the RSRP hysteresis threshold, the device may determine that the RSRP difference hysteresis condition is not satisfied and proceed to selecting the data subscription for SDT operation based on another condition.

Responsive to determining that the first RSRP difference associated with the first data subscription is not greater than the second RSRP difference associated with the second data subscription at 1012, the device may proceed to evaluating the second RSRP difference against the RSRP difference hysteresis condition at 1016. After the device determines the RSRP difference hysteresis threshold, the device compares the second RSRP difference associated with the second data subscription to the RSRP difference hysteresis threshold to determine if the second RSRP difference is greater than the RSRP hysteresis threshold. If the second RSRP difference is greater than the RSRP hysteresis threshold, the device may determine that the RSRP difference hysteresis condition is satisfied and the device selects, at 1020 and based on the higher RSRP difference, the second data subscription for SDT operations, such as enhanced SDT operations with conditional transmission. If the second RSRP difference is not greater than (e.g., less than or equal to) the RSRP hysteresis threshold, the device may determine that the RSRP difference hysteresis condition is not satisfied and proceed to selecting the data subscription for SDT operation based on another condition, such as data volume.

Responsive to determining that the RSRP difference condition is not satisfied at 1014 or 1016 for the first or second RSRP difference, the device may proceed to determining SDT data volumes for the data subscriptions at 1022. For example, the device may determine a SDT data volume threshold for both data subscriptions. To illustrate, the device may determine a first SDT data volume threshold for the first data subscription based on the first SIB1 message associated with first data subscription and may determine a second SDT data volume threshold for the second data subscription based on the second SIB1 message associated with second data subscription.

After determining the SDT data volume thresholds for both data subscriptions at 1022, the device may proceed to evaluating the SDT data volume thresholds. For example, the device may determine if the first SDT data volume threshold associated with the first data subscription is equal to the second SDT data volume threshold associated with the second data subscription at 1024. If the first SDT data volume threshold is equal to the second SDT data volume threshold, the device may determine that the SDT equality condition/evaluation at 1024 is satisfied. Responsive to determining that the SDT equality condition/evaluation is satisfied at 1024, the device may proceed to selecting the data subscription based on anther condition. As illustrated in the example of FIG. 10, the device reverts back to the RSRP difference condition and selects the data subscription based on the data subscription that had the highest or greatest RSRP difference at 1026. To illustrate, if the first RSRP difference was greater than the second RSRP difference and the device chose the left path (e.g., compared the first RSRP difference to the RSRP difference hysteresis threshold), the device would select the first data subscription for SDT operations. If the first SDT data volume threshold is equal to the second SDT data volume threshold, the device may determine that the SDT equality condition/evaluation is not satisfied and continue to proceed with selecting the data subscription for SDT operations based on higher SDT data volume capabilities.

After determining the SDT data volume thresholds for both data subscriptions at 1022, and optionally that the SDT equality condition is not satisfied at 1024, the device may proceed to evaluating the SDT data volume thresholds at 1028. For example, the device may determine if the first SDT data volume threshold associated with the first data subscription is greater than the second SDT data volume threshold associated with the second data subscription.

Responsive to determining that the first SDT data volume threshold associated with the first data subscription is greater than the second SDT data volume threshold associated with the second data subscription at 1028, the device may determine that the data volume condition is satisfied, and the device selects, at 1030 and based on the higher data volume, the first data subscription for SDT operations, such as enhanced SDT operations with conditional transmission.

Responsive to determining that the first SDT data volume threshold associated with the first data subscription is not greater than (e.g., less than) the second SDT data volume threshold associated with the second data subscription at 1028, the device may determine that the data volume condition is not satisfied, and the device selects, at 1032 and based on the higher data volume, the second data subscription for SDT operations, such as enhanced SDT operations with conditional transmission.

Although the example of FIG. 10 illustrates an example where the RSRP difference hysteresis condition is compared to the determined higher RSRP difference, in other implementations the device may determine a difference between the RSRP differences of the data subscriptions and then compare the determined difference (of the RSRP differences) to the RSRP difference hysteresis threshold value to determine if the RSRP difference hysteresis condition is satisfied. If the RSRP difference hysteresis condition is satisfied, the device may proceed to selecting the higher data subscription similar to the operations at 1012. If the RSRP difference hysteresis condition is not satisfied, the device may skip selecting the data subscription based on RSRP difference, such as skip any of operations 1012-1020, and proceed to data volume based data subscription selection as in the operations at 1022-1032. The above alternative where the RSRP difference hysteresis condition is applied before determining which data subscription has a higher RSRP difference may be functionally equivalent to the example illustrated in FIG. 10 where the hysteresis condition is applied after determining which data subscription has a higher RSRP difference.

Additionally, or alternatively, one or more operations of FIGS. 3A-10 may be added, removed, substituted in other implementations. For example, in some implementations, the example steps of FIGS. 3A and 3B may be used together with the example steps of FIG. 3C. To illustrate, the steps of FIG. 3A or 3B may be performed and then at a later time, the steps of 3C may be performed. As another example, some of the steps of first SDT transmission in FIG. 5 or some of the steps of second SDT transmission in FIG. 6 may be used with or added to the steps of any of FIG. 3A-3C, or 7-10.

FIGS. 11A-11C are each a diagram illustrating an example scenario of conditional SDT operations according to some embodiments of the present disclosure. The example of FIG. 11A involves obtaining two pieces of mail small data within a latency condition/threshold for the first mail data and transmitting both pieces of small data in a single SDT.

Referring to FIG. 11A, during operation 4 kilobytes (KB) of first mail small data is received at a first time at 1 second and 4 KB of second mail small data is received at a second time at 3 seconds. The device places the first mail small data in the buffer and may begin to evaluate SDT conditional transmission conditions, such as in FIG. 9, at the first time. For example, the device may determine that the first mail small data has a latency condition (e.g., latency tolerance) of 5 seconds based on the type of small data, mail type, and that the communication link (or SDT buffer) associated with the first mail small data has a data volume of 8 KB for small data transmissions. The device may then proceed to periodically evaluate the SDT conditional transmission conditions after the first time, such as up until the expirations of the 5 second latency threshold at 6 seconds.

In the example of FIG. 11A, the device determines that the SDT data volume or buffer condition is satisfied at or after the second time, based upon the receipt of the second mail small data, and the device transmits the first and second mail small data together in a single SDT message. To illustrate, a sum of the amounts of first and second mail small data (8 KB) may satisfy a SDT data volume or data buffer condition (e.g., greater than or equal to an 8 KB threshold), and the device my determine that a SDT condition is satisfied and transmit all the small data in the buffer or all the small data it can under the SDT data volume threshold. The device may combine two PDCP packets at the PDCP layer to combine the first and second mail small data for transmission together responsive to determination of one or more SDT transmission conditions being satisfied. In other examples, the device may transmit the first mail small data prior to the second time if another SDT conditional transmission condition is satisfied. For example, the device may transmit the first mail small data at 2 seconds responsive to the RSRP and/or TA timer conditions being satisfied.

The example of FIG. 11B involves obtaining a second piece of location small data within a latency condition/threshold for a first piece of mail small data and transmitting both pieces of small data in a single SDT based on a latency condition/threshold for a second piece of location small data.

Referring to FIG. 11B, during operation 4 KB of mail small data is received at a first time at 1 second and 1 KB of location small data is received at a second time at 2 seconds. The device places the mail small data in the buffer and may begin to evaluate SDT conditional transmission conditions, such as in FIG. 9, at the first time. For example, the device may determine that the mail small data has a latency condition (e.g., latency tolerance) of 5 seconds based on the type of small data, mail type, and that the communication link (or SDT buffer) associated with the first mail small data has a data volume of 8 KB for small data transmissions.

The device may then proceed to periodically evaluate the SDT conditional transmission conditions after the first time.

In the example of FIG. 11B, the device determines that a second SDT latency condition is satisfied at or after the second time, based upon the receipt of the location small data, and the device transmits the mail small data and the location small data together in a single SDT message prior to the expiration of the latency condition of the mail small data at 6 seconds. To illustrate, the location small data may have a second latency condition of less than a second, such as 0.25 seconds, and the device may transmit the mail and location small data after the second time at or shortly after the expiration of the second latency condition for the location small data, and well prior to the sixth second and the expiration of the latency condition for the mail small data. The device may combine two PDCP packets at the PDCP layer to combine the mail small data and the location small data for transmission together.

The example of FIG. 11C involves obtaining a second piece of message small data within a latency condition/threshold for a first piece of mail small data and transmitting both pieces of small data in a single SDT based on receiving a third piece of small data which is too large for transmission with the first and second pieces of small data, that is the three pieces of data exceeding a SDT amount or buffer threshold.

Referring to FIG. 11C, during operation 4 KB of mail small data is received at a first time at 1 second, 1 KB of message small data is received at a second time at 2 seconds, and optionally 1 KB of location small data is received at a third time at 4 seconds. The device places the mail small data in the buffer and may begin to evaluate SDT conditional transmission conditions, such as in FIG. 9, at the first time similar to the examples of FIGS. 11A and 11B.

In the example of FIG. 11C, the device determines that a second SDT latency condition is satisfied at or after the second time, based upon the receipt of the message small data, and the device transmits the mail small data and the message small data together in a single SDT message. To illustrate, the message small data may have a second latency condition (e.g., latency tolerance) of 3 seconds based on the type of small data, message type, and which expires prior to the latency condition for the mail small data. Thus, the device may transmit the mail and message small data together at or prior to the expiration of the second latency condition for the message small data, such as 5 seconds.

In other examples, the device may receive additional small data, which may alter when and what small data it transmits. For example, if the device receives the 1 KB of location small data at the third time at 4 seconds, the device may transmit all of the small data together upon expiration of a third latency condition for the location small data (e.g., around 4.25 seconds) and prior to the expiration of both latency conditions for the mail and message small data at 6 and 5 seconds respectively.

Alternatively, in some implementations, the device may prioritize small data with shorter latency times for transmission over small data types with longer latency times. For example, the device may prioritize location and/or message small data for transmission, and may delay the mail small data. To illustrate, if the device receives the 1 KB of location small data at the third time at 4 seconds, the device may transmit the message and location small data together around 4.25 seconds and prior to the expiration of both latency conditions for the mail and message small data at 6 and 5 seconds respectively, and the device may refrain from sending the mail small data with the other small data.

The device may continue to evaluate the SDT transmission conditions and send the mail small data responsive to determining a second SDT condition is satisfied (e.g., data volume again or latency condition for mail small data). In some such implementations, the device may choose to refrain from sending the mail small data based on one or more other conditions, such as a latency difference condition, the data volume condition, a type condition, etc. To illustrate, the device may choose to not prioritize or to not leave data out unless the data being left out still has X percentage or amount of the delay period left, unless the data volume is met by higher priority or lower latency data, etc.

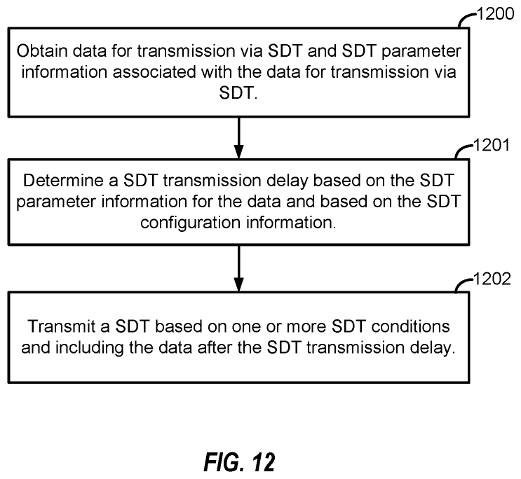

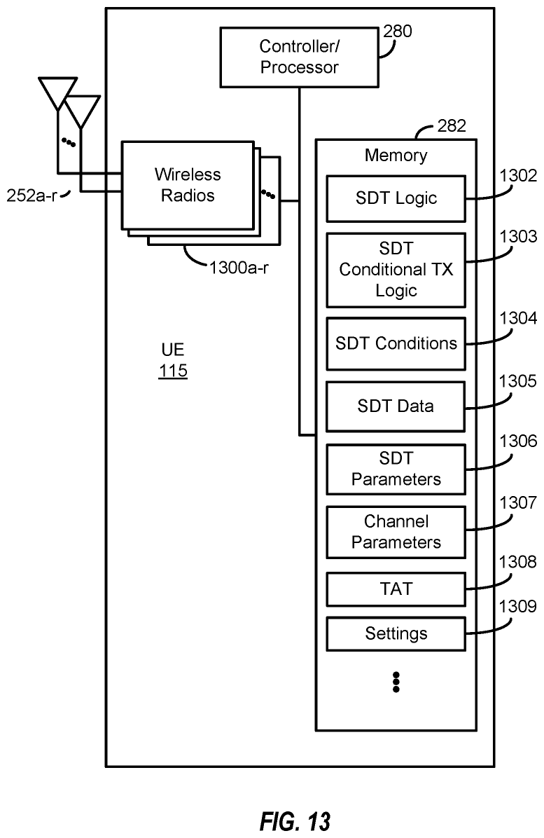

FIG. 12 is a flow diagram illustrating example blocks executed by a UE configured according to an aspect of the present disclosure. The example blocks will also be described with respect to UE 115 as illustrated in FIG. 13. FIG. 13 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1300a-r and antennas 252a-r. Wireless radios 1300a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 13, memory 282 stores SDT logic 1302, SDT conditional transmission logic 1303, SDT transmission condition information 1304, SDT data 1305, SDT parameter information 1306, channel parameter information 1307, TAT 1308, and settings data 1309.

At block 1200, a wireless communication device, such as a UE, obtains data for transmission via SDT and SDT parameter information associated with the data for transmission via SDT. For example, the data for transmission via SDT may include or correspond to the first small data, the second small data, or the third small data of any of FIGS. 3A-11C. The SDT parameter information may include or correspond to the SDT parameter information 442 of FIG. 4. To illustrate, the UE 115 may receive and/or generate small quantities (e.g., an amount of data under a data volume threshold) of certain type of data, such as mail data, messaging data, or location data, as illustrative, non-limiting examples, for transmission via SDT protocol.

At block 1201, the UE 115 determines a SDT transmission delay based on the SDT parameter information for the data and based on the SDT configuration information. For example, the SDT transmission delay may include or correspond to a delay as illustrated in any of FIG. 5, 6, or 11A-11C. To illustrate, the UE 115 determines to skip a first or next SDT TXOP after obtaining the small data and transmits a SDT including the small data after a delay, such as the delay 540 or 640. The UE 115 may determine a SDT latency time associated with a type of the small data, such as x ms for location data, as described with reference to FIGS. 11A-11C, and the delay may correspond to a period of time that is after the first SDT TXOP and within the SDT latency time (or SDT latency window).

At block 1202, the UE 115 transmits a SDT based on one or more SDT conditions and including the data after the SDT transmission delay. For example, the SDT may include or correspond to the first SDT transmission 454 or the second SDT transmission 456 of FIG. 4, the SDT at 545 of FIG. 5, any of the SDTs at 645-650 of FIG. 6, any of the SDTs at 715 or 745 of FIG. 7, any of the SDTs at 840, 845, or 865 of FIG. 8, or any of the SDTs of FIGS. 11A-11C. The one or more SDT conditions may include or correspond to any of the SDT conditional transmission conditions of the trigger condition data 406 of FIG. 4. To illustrate, the UE 115 may perform the operations illustrated in FIG. 9 to evaluate the SDT conditional transmission conditions before determining to transmit the first SDT 454 based on the determining that one or more of the SDT conditional transmission conditions have been satisfied. The UE 115 may determine that the SDT conditional transmission conditions are satisfied based on the small data itself and/or the parameter information thereof, such as the SDT parameter information 442 of FIG. 4. The SDT may occur in a non-connected state, such as RRC INACTIVE.

The UE 115 may execute additional blocks (or the UE 115 may be configured further perform additional operations) in other implementations. For example, the UE 115 may perform one or more operations described above.

In a first aspect, a device for wireless communication includes at least one processor; and a memory coupled to the at least one processor. The at least one processor is configured to cause the device to: receive small data transmission (SDT) configuration information; obtain data for transmission via SDT and SDT parameter information associated with the data for transmission via SDT; determine a SDT transmission delay based on the SDT parameter information for the data and based on the SDT configuration information; and transmit a SDT based on one or more SDT transmission conditions and including the data, the SDT transmitted at or within the SDT transmission delay.

In a second aspect, alone or in combination with one or more of the above aspects, the SDT is transmitted in a first SDT transmission opportunity (TXOP), and wherein the at least one processor is further configured to cause the device to: refrain, prior to transmitting the SDT in the first SDT TXOP, from transmitting the SDT in a second SDT TXOP which occurs before the first SDT TXOP and is a next TXOP after the data is obtained for transmission via SDT.

In a third aspect, alone or in combination with one or more of the above aspects, the SDT parameter information includes a size of the data, a type of the data, a service associated with the data, or a combination thereof.

In a fourth aspect, alone or in combination with one or more of the above aspects, the at least one processor is further configured to cause the device to: obtain second data for transmission via SDT and second SDT parameter information associated with the second data for transmission via SDT, the second data corresponding to second small data different than first small data of the data; and determine a second SDT transmission delay based on the second SDT parameter information for the second data and based on the SDT configuration information, wherein the SDT transmitted at or within the second SDT transmission delay.

In a fifth aspect, alone or in combination with one or more of the above aspects, the SDT transmission conditions include a maximum data condition and a latency condition.

In a sixth aspect, alone or in combination with one or more of the above aspects, the SDT transmission conditions include one or more of a maximum data condition, a latency condition, a time alignment timer (TAT) expiration condition, or a quality condition (e.g., RSRP, RSRQ, SNR, etc.).

In a seventh aspect, alone or in combination with one or more of the above aspects, the latency condition includes a plurality of latency conditions or thresholds, including a mail latency condition, a message latency condition, a location latency condition, or a combination thereof.

In an eighth aspect, alone or in combination with one or more of the above aspects, the SDT transmission conditions include a maximum data condition, and wherein the at least one processor is further configured to cause the device to: determine whether an amount of small data in a small data buffer corresponding to the data and optionally second data is greater than or equal to the maximum data condition; and determine to transmit the small data in the small data buffer in a next SDT TXOP based on a determination that the amount of small data in the small data buffer is greater than or equal to the maximum data condition, wherein the SDT is transmitted prior to the SDT transmission delay.

In a ninth aspect, alone or in combination with one or more of the above aspects, the SDT transmission conditions include a latency condition, and wherein the at least one processor is further configured to cause the device to: determine whether a latency timer associated with the data satisfies the latency condition; determine to transmit the data responsive to a determination that latency timer associated with the data satisfies the latency condition.

In a tenth aspect, alone or in combination with one or more of the above aspects, the SDT transmission conditions include a time alignment timer (TAT) condition, and wherein the at least one processor is further configured to cause the device to: configure a TAT based on TAT configuration information received from a network (e.g., network device or base station); determine whether the TAT satisfies the TAT timer condition; and determine to transmit the data responsive to a determination that the TAT satisfies the TAT condition.

In an eleventh aspect, alone or in combination with one or more of the above aspects, the SDT transmission conditions include reference signal receive power (RSRP) condition, and wherein the at least one processor is further configured to cause the device to: determine whether a RSRP associated with the device satisfies the RSRP condition; and determine to transmit the data responsive to a determination that the RSRP satisfies the RSRP condition.

In a twelfth aspect, alone or in combination with one or more of the above aspects, the at least one processor is further configured to cause the device to: combine first small data corresponding to the data and second small data at a PDCP layer to generate a combined small data PDCP packet based on a determination that at least one of the one or more SDT transmission conditions have been satisfied, wherein the SDT transmitted includes the combined small data PDCP packet.

In a thirteenth aspect, alone or in combination with one or more of the above aspects, the device is operating in a dual data subscription mode, and wherein the SDT configuration information is received from a first subscription, wherein the at least one processor is further configured to cause the device to: receive second SDT configuration information for a second subscription; obtain second data for transmission via SDT and second SDT parameter information associated with the second data for transmission via SDT; determine a second SDT transmission delay based on the second SDT parameter information for the data and based on the second SDT configuration information; and transmit a second SDT based on one or more second SDT transmission conditions and including the second data, the second SDT transmitted at or within a second SDT transmission delay.

In a fourteenth aspect, alone or in combination with one or more of the above aspects, the at least one processor is further configured to cause the device to: receive a RRC release message including suspend configuration information, the suspend configuration information indicating the SDT configuration information; or receive a RRC release message including configured grant (CG) resource configuration information and suspend configuration information, the suspend configuration information indicating the SDT configuration information.

In a fifteenth aspect, alone or in combination with one or more of the above aspects, the SDT is transmitted in a RACH request in an RRC inactive mode, and wherein the at least one processor is further configured to cause the device to: initiate RACH operations with a base station after determining to transmit the SDT, wherein the at least one processor configured to cause the device to transmit the SDT includes to: transmit the SDT in a MSG A or in a MSG 1; complete RACH operations; and transmit one or more second SDTs based on the one or more SDT transmission conditions.

In a sixteenth aspect, alone or in combination with one or more of the above aspects, the SDT is transmitted in first CG resources with a RRC resume request in an RRC inactive mode, and wherein the at least one processor is further configured to cause the device to: resume link and switch to RRC connected responsive to the transmission of the SDT; receive direct grant responsive to the transmission of the SDT; and transmit second SDT based on the direct grant and on the one or more SDT transmission conditions.

In a seventeenth aspect, alone or in combination with one or more of the above aspects, the device is operating in a dual data subscription mode, and wherein the at least one processor is further configured to cause the device to: determine a first RSRP threshold associated with a first data subscription and a second RSRP threshold associated with a second data subscription; determine a first RSRP value associated with the first data subscription and a second RSRP value associated with the second data subscription; determine a first RSRP difference based on a difference of the first RSRP value and the first RSRP threshold; determine a second RSRP difference based on a difference of the second RSRP value and the second RSRP threshold; compare the first RSRP difference and the second RSRP difference; and select the first data subscription and the first RSRP difference based on the comparison, wherein the first RSRP difference is greater than the second RSRP difference.

In an eighteenth aspect, alone or in combination with one or more of the above aspects, the device is operating in a dual data subscription mode, and wherein the at least one processor is further configured to cause the device to: determine a first data volume threshold associated with a first data subscription; determine a second data volume threshold associated with a second data subscription; compare the first data volume threshold and the second data volume threshold; and select the first data subscription and the first data volume threshold for use as a data volume threshold of the SDT transmission conditions based on the comparison.

In a nineteenth aspect, alone or in combination with one or more of the above aspects, a method for wireless communication includes: receiving small data transmission (SDT) configuration information; obtaining data for transmission via SDT and SDT parameter information associated with the data for transmission via SDT; determining a SDT transmission delay based on the SDT parameter information for the data and based on the SDT configuration information; and transmitting a SDT based on one or more SDT transmission conditions and including the data, the SDT transmitted at or within the SDT transmission delay.

In a twentieth aspect, alone or in combination with the nineteenth aspect, the SDT transmission conditions include one or more of a maximum data condition, a latency condition, a time alignment timer (TAT) expiration condition, or a quality condition (e.g., RSRP).

Accordingly, the UE 115 and network entity 405 may be able to more efficiently perform small data transmissions by grouping small data together for transmission reducing power consumption and wasted network bandwidth. Thus, FIG. 4 describes enhanced conditional transmission of small data operations. Using conditional transmission of small data operations may enable efficiency improvements, such as power and/or bandwidth conservation. Performing enhanced conditional transmission of small data operations enables reduced bandwidth/spectrum waste when performing small data transmissions and thus, enhanced UE and network performance by increasing throughput and reducing latency for other devices and the network as a whole.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 1-13 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor,
wherein the at least one processor is configured to cause the device to:
receive small data transmission (SDT) configuration information;
obtain data for transmission via SDT and SDT parameter information associated with the data for transmission via SDT;
determine a SDT transmission delay based on the SDT parameter information for the data and based on the SDT configuration information; and
transmit a SDT based on one or more SDT transmission conditions and including the data, the SDT transmitted at or within the SDT transmission delay.

2. The device of claim 1, where the SDT is transmitted in a first SDT transmission opportunity (TXOP), and wherein the at least one processor is further configured to cause the device to:
refrain, prior to transmitting the SDT in the first SDT TXOP, from transmitting the SDT in a second SDT TXOP which occurs before the first SDT TXOP and is a next TXOP after the data is obtained for transmission via SDT.

3. The device of claim 1, wherein the SDT parameter information includes a size of the data, a type of the data, a service associated with the data, or a combination thereof.

4. The device of claim 1, wherein the at least one processor is further configured to cause the device to:
obtain second data for transmission via SDT and second SDT parameter information associated with the second data for transmission via SDT, the second data corresponding to second small data different than first small data of the data; and
determine a second SDT transmission delay based on the second SDT parameter information for the second data and based on the SDT configuration information, wherein the SDT transmitted at or within the second SDT transmission delay.

5. The device of claim 1, wherein the SDT transmission conditions include a maximum data condition and a latency condition.

6. The device of claim 1, wherein the SDT transmission conditions include one or more of a maximum data condition, a latency condition, a time alignment timer (TAT) expiration condition, or a quality condition.

7. The device of claim 6, wherein the latency condition includes a plurality of latency conditions or thresholds, including a mail latency condition, a message latency condition, a location latency condition, or a combination thereof.

8. The device of claim 1, wherein the SDT transmission conditions include a maximum data condition, and wherein the at least one processor is further configured to cause the device to:
determine whether an amount of small data in a small data buffer corresponding to the data and optionally second data is greater than or equal to the maximum data condition; and
determine to transmit the small data in the small data buffer in a next SDT TXOP based on a determination that the amount of small data in the small data buffer is greater than or equal to the maximum data condition, wherein the SDT is transmitted prior to the SDT transmission delay.

9. The device of claim 1, wherein the SDT transmission conditions include a latency condition, and wherein the at least one processor is further configured to cause the device to:
determine whether a latency timer associated with the data satisfies the latency condition; and
determine to transmit the data responsive to a determination that latency timer associated with the data satisfies the latency condition.

10. The device of claim 1, wherein the SDT transmission conditions include a time alignment timer (TAT) condition, and wherein the at least one processor is further configured to cause the device to:
configure a TAT based on TAT configuration information received from a network;
determine whether the TAT satisfies the TAT condition; and
determine to transmit the data responsive to a determination that the TAT satisfies the TAT condition.

11. The device of claim 1, wherein the SDT transmission conditions include a reference signal receive power (RSRP) condition, and wherein the at least one processor is further configured to cause the device to:
determine whether a RSRP associated with the device satisfies the RSRP condition; and
determine to transmit the data responsive to a determination that the RSRP satisfies the RSRP condition.

12. The device of claim 1, wherein the at least one processor is further configured to cause the device to:
combine first small data corresponding to the data and second small data at a packet data convergence protocol (PDCP) layer to generate a combined small data PDCP packet based on a determination that at least one of the one or more SDT transmission conditions have been satisfied, wherein the SDT transmitted includes the combined small data PDCP packet.

13. The device of claim 1, wherein the device is operating in a dual data subscription mode, and wherein the SDT configuration information is received from a first subscription, wherein the at least one processor is further configured to cause the device to:
receive second SDT configuration information for a second subscription;
obtain second data for transmission via SDT and second SDT parameter information associated with the second data for transmission via SDT;
determine a second SDT transmission delay based on the second SDT parameter information for the data and based on the second SDT configuration information; and
transmit a second SDT based on one or more second SDT transmission conditions and including the second data, the second SDT transmitted at or within a second SDT transmission delay.

14. The device of claim 1, wherein the at least one processor is further configured to cause the device to:
receive a radio resource control (RRC) release message including suspend configuration information, the suspend configuration information indicating the SDT configuration information; or
receive a RRC release message including configured grant (CG) resource configuration information and suspend configuration information, the suspend configuration information indicating the SDT configuration information.

15. The device of claim 1, wherein the SDT is transmitted in a random access channel (RACH) request in an RRC inactive mode, and wherein the at least one processor is further configured to cause the device to:
initiate RACH operations with a base station after determining to transmit the SDT, wherein the at least one processor configured to cause the device to transmit the SDT includes to:
transmit the SDT in a message (MSG) MSG A or in a MSG 1;
complete RACH operations; and
transmit one or more second SDTs based on the one or more SDT transmission conditions.

16. The device of claim 1, wherein the SDT is transmitted in first CG resources with a radio resource control (RRC) resume request in an RRC inactive mode, and wherein the at least one processor is further configured to cause the device to:
resume link and switch to RRC connected responsive to the transmission of the SDT;
receive direct grant responsive to the transmission of the SDT; and
transmit second SDT based on the direct grant and on the one or more SDT transmission conditions.

17. The device of claim 1, wherein the device is operating in a dual data subscription mode, and wherein the at least one processor is further configured to cause the device to:
determine a first reference signal receive power (RSRP) threshold associated with a first data subscription and a second RSRP threshold associated with a second data subscription;
determine a first RSRP value associated with the first data subscription and a second RSRP value associated with the second data subscription;
determine a first RSRP difference based on a difference of the first RSRP value and the first RSRP threshold;
determine a second RSRP difference based on a difference of the second RSRP value and the second RSRP threshold;
compare the first RSRP difference and the second RSRP difference; and
select the first data subscription and the first RSRP difference based on the comparison, wherein the first RSRP difference is greater than the second RSRP difference.

18. The device of claim 1, wherein the device is operating in a dual data subscription mode, and wherein the at least one processor is further configured to cause the device to:
determine a first data volume threshold associated with a first data subscription;
determine a second data volume threshold associated with a second data subscription;
compare the first data volume threshold and the second data volume threshold; and
select the first data subscription and the first data volume threshold for use as a data volume threshold of the SDT transmission conditions based on the comparison.

19. A method for wireless communication, comprising:
receiving small data transmission (SDT) configuration information;
obtaining data for transmission via SDT and SDT parameter information associated with the data for transmission via SDT;
determining a SDT transmission delay based on the SDT parameter information for the data and based on the SDT configuration information; and
transmitting a SDT based on one or more SDT transmission conditions and including the data, the SDT transmitted at or within the SDT transmission delay.

20. The method of claim 19, wherein the SDT transmission conditions include one or more of a maximum data condition, a latency condition, a time alignment timer (TAT) expiration condition, or a quality condition.
